(19) United States
(12) Patent Application Publication
(10) Pub. No.: US 2012/0017052 A1
(43) Pub. Date: Jan. 19, 2012

(54) Information Handling System Universal Memory Wear Leveling System and Method

(76) Inventor: William F. Sauber, Georgetown, TX (US)

(21) Appl. No.: 12/839,042

(22) Filed: Jul. 19, 2010

(51) Int. Cl. G06F 12/00

(52) U.S. Cl. 711/154; 711/173; 711/E12.001

(57) ABSTRACT

An information handling system universal memory architecture assigns memory blocks to information handling system functions, such as a persistent storage function and a working storage function, that have different relative rates of writes of information. The blocks are periodically analyzed for remaining memory life to reassign blocks to functions that result in wear leveling across the blocks. For example, blocks having relatively low life remaining that are assigned to functions having a relatively high number of writes have their function switched with blocks that have a relatively high life remaining that are assigned to functions having a relatively low number of writes. In addition, wear leveling performed within a block ensures even wear of the memory cells within the block.

### BACKGROUND OF THE INVENTION

1. Field of the Invention

The present invention relates in general to the field of information handling system memory, and more particularly to a system and method for information handling system universal memory wear leveling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems generate and store information. In order to store information, information handling systems rely on memory devices. The type of memory devices that are used by an information handling system depends upon the function performed by the information handling system. Conventional information handling systems use volatile memory, such as DRAM, where a rapid response time is needed and non-volatile memory, such as flash memory or a hard disk drive, in order to store information during periods when the information handling system and memory are powered down. For example, an information handling system with a conventional memory architecture stores firmware boot instructions in flash memory, such as a BIOS, that instructs the information handling system upon power up to read and execute an operating system stored on a hard disk drive. Conventional BIOS memory provides persistence and executes without moving parts, however, is difficult to program or burn. The operating system is read from the hard disk drive to volatile RAM so that a processor can rapidly access and execute operating system instructions. The hard disk drive provides persistence with flexible reads and writes, while RAM provides rapid processor access to information and rapid reads and writes. The operating system instructions support execution of other applications by the processor, such as word processing or web browsing, by calling the applications to the RAM for ready execution by the processor. Information generated by the applications that the end user desires to maintain after power down of the information handling system is typically stored back to the hard disk drive. Thus, memory in conventional information handling systems is generally categorized by the function supported by the memory. “Persistent” storage is the file system or similar data stored in the hard disk drive so that the data persists after power down; “working” storage is system memory that supports operation of the processor when the information handling system is powered up where the information does not persist after power down of the information handling system; and “firmware” storage is instructions stored in flash memory that aid power up of the information handling system and interaction of the components where the instructions are changed only infrequently.

Conventional memory architecture has a disadvantage in that information is frequently transferred between memory devices of different types during normal operations of an information handling system. Recent improvements in the performance of non-volatile memory has resulted in the proposal of a universal storage architecture that uses a single type of memory to perform persistent storage, working storage and firmware storage functions so that each memory may be accessed using a single linear address space. Universal memory will reduce data transfers and command interfaces between working and persistent storage for better performance with less complexity and power consumption than is typical with conventional memory architectures, including better power management opportunities and faster start, resume and shutdown times. One step towards the use of a universal storage architecture is the use of flash memory in solid state drives to replace hard disk drives. Essentially, the same type of memory performs persistent storage and firmware storage functions. However, flash memory generally has too slow of a write speed for it to operate in anything more than a very basic system as working storage. Over the next ten years, alternative semiconductor storage technologies, such as phase change memory, are expected to reach commodity status that will make universal storage architectures commercially feasible for general use in information handling systems. These future “flash” type semiconductor memory devices will provide data retention times similar to current flash memory with better endurance, will provide read performance similar to DRAM, will provide write performance and granularity similar to DRAM and will cost less than NOR flash.

One difficulty with flash and flash-type memories that support a universal memory architecture is that such memories have a limited number of writes after which the memory becomes unreliable. One technique that helps to lengthen the usable life of flash memories is wear leveling. Wear leveling attempts to balance wear from writes to flash type memory by spreading writes over the entire memory. Over time, avoiding concentrations of writes in particular portions of the memory helps to prevent failure at the “over-written” portions before other portions that receive fewer writes. Although wear leveling extends the life of memory by spreading writes more evenly across a memory, wear leveling does add overhead to information handling system operations and makes memory usage more complex.

### SUMMARY OF THE INVENTION

Therefore a need has arisen for a system and method which supports wear leveling in a universal memory architecture.

In accordance with the present invention, a system and method are provided which substantially reduce the disadvantages and problems associated with previous methods and systems for memory wear leveling. A universal memory is broken into blocks that are each assigned based upon a selection of plural storage functions where the storage functions have varying associated write rates. The blocks are periodically reassigned storage functions based upon life remaining for each block so that the blocks have wear leveling enforced by the varying write rates of the functions. Between function reassignments, wear leveling is provided within each block as needed to maintain level wear within the block.

More specifically, an information handling system is built from components, such as a processor and a memory. The memory has a universal architecture that provides both persistent storage and working storage functions. A memory life manager assigns blocks of memory to provide support for either a persistent storage function or a working storage function so that the processor writes information associated with a persistent storage function to blocks assigned to persistent storage and writes information associated with a working storage function to blocks assigned to working storage. Periodically, such as at predetermined events, memory life of the blocks is analyzed to reassign persistent storage blocks to working storage functions and to reassign working storage blocks to persistent storage functions. For example, a block of persistent storage has its information swapped with a block of working storage if the difference of the life remaining of the blocks exceeds a threshold. By comparing blocks in an order of greatest life remaining compared to least life remaining, wear leveling is accomplished through selective reassignment of block functions that provide a greater number of writes to blocks having relatively greater remaining life. In addition, wear leveling is accomplished within each block by evening the writes across the memory cells, where a memory cell may be the basic or smallest memory region which can be written, of a particular block so that each block has a relatively even wear.

The present invention provides a number of important technical advantages. One example of an important technical advantage is that a universal memory architecture has wear leveling performed with blocks of memory assigned by functions so that memory access is supported in an organized and less complex manner. Wear leveling within a functional block helps to ensure that uniform wear occurs in each block so that functional assignments to blocks are more effective. By focusing wear leveling through optimally-sized functional blocks, reduced overhead from wear leveling allows improved information handling system operations. For example, memory overhead is reduced with less frequent data swaps to level wear and with larger data swaps that can be timed to occur when resources are available to perform the data swaps.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having a universal memory with function-based wear leveling; and

FIG. 2 depicts a flow diagram of a process for performing function-based wear leveling.

### DETAILED DESCRIPTION

Function-based wear leveling of information handling system memory efficiently addresses memory wear by selectively assigning write-intensive functions to memory having relatively greater remaining wear. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

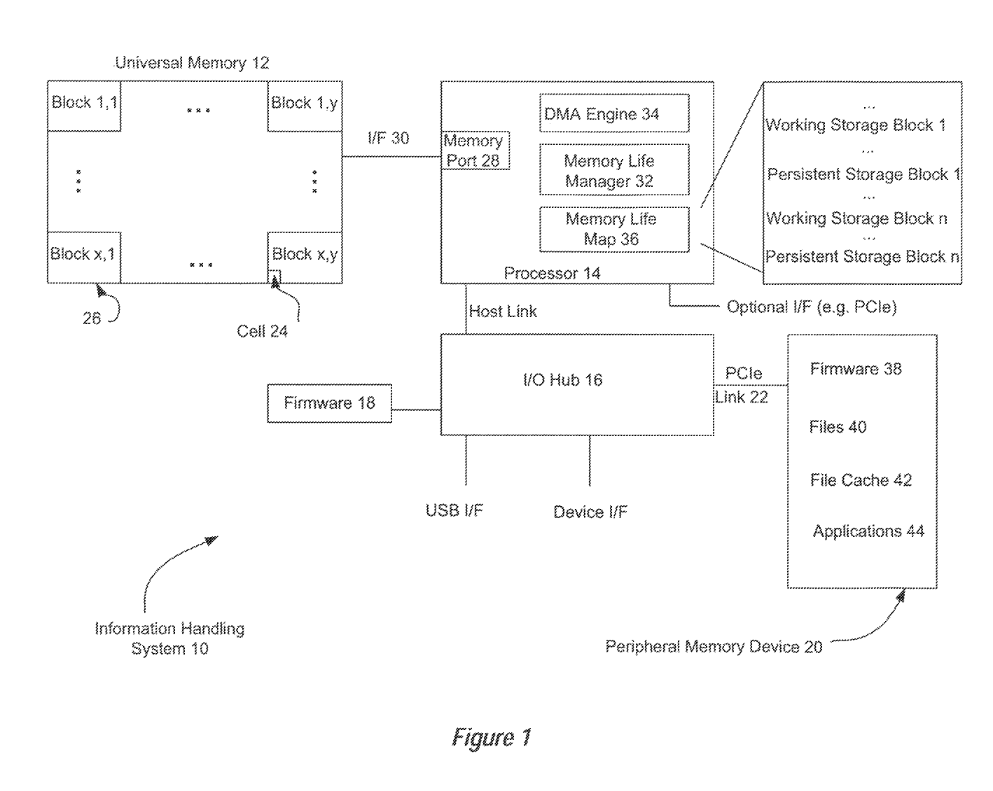

Referring now to FIG. 1, a block diagram depicts an information handling system 10 having a universal memory architecture 12 with function-based wear leveling. Information handling system 10 is built from a variety of components that cooperate to process information, such as a processor 14 that executes instructions, an I/O hub 16 that coordinates inputs and outputs, and memory including universal memory 12 that interfaces directly with processor 14 and other memory devices that interface through I/O hub 16, such as firmware 18 associated with hardware devices and a peripheral memory device 20 that interfaces through a PCI Express link 22. Peripheral memory device 20 provides an alternative embodiment in which additional memory is available to supplement a universal memory architecture, such as with DRAM or with a flash memory that might also assume a universal memory architecture. The memory devices store a variety of types of information including at least information categorized by functions of working storage and persistent storage. Working storage functions include the functions typically supported by DRAM in conventional memory architectures, such as storing information generated by processor 14 during operation of information handling system 10. Persistent storage functions include the functions typically supported by persistent memory in conventional memory architectures, such as applications stored on a hard disk drive.

One consideration in differentiating working storage and persistent memory functions is the frequency of writes performed to the memory by the function. As an example, a word processing application that is called for execution is called from persistent memory to working memory; the application stored in persistent memory has few if any writes made to it while the application executing in working storage is actively used by the processor and generally experiences multiple writes over a normal usage period. During execution of the word processing application from the persistent storage memory on the working storage memory, data is sometimes created, such as a document, that the end user desires to keep after power down of information handling system 10; data stored for recall after a power down is stored in persistent storage memory. Although the terms “working storage” and “persistent storage” relate a universal memory architecture to conventional memory terminology, one of skill in the art will understand that a classification of a particular function as working or persistent storage may be further clarified by the number of writes typically associated with the function. For example, data generated by one type of application might be classified as working storage because the data is frequently re-written while data generated by another type of application might be classified as persistent storage because the data is stored with minimal re-writes. Some experimentation by one of skill the art in a given memory architecture will improve and optimize the classification of information by function to provide function-based wear leveling, including the use of multiple classification functions or sub-functions in addition to working and persistent storage functions. One example is a firmware function, such as a BIOS, which is only rarely re-written. Another example is a video frame buffer, which stores video information for quick access by a graphics processor and is frequently re-written.

Information handling system 10 leverages function identification of information to level memory wear by associating function of information and the expected frequency of writes to memory that stores the information. Within universal memory 12, memory cells 24 are divided into blocks 26 where each block is, for example, a group of adjacent cells having a uniform size, such as 4 KB blocks, 1 MB blocks, or multiple MB blocks. Processor 14 writes to universal memory 12 through a memory port 28 and a memory interface 30. Processor 14 has a memory life manager 32 that determines the blocks 26 that accept working storage and the blocks 26 that accept persistent storage. Since memory life deteriorates base on the number of writes, memory life manager 32 identifies blocks with relatively less memory life as persistent storage blocks and blocks with relatively greater memory life as working storage blocks. A DMA engine 34 moves information between blocks in response to determinations by memory life manage 32 that identified blocks should shift between working storage and persistent storage functions. A memory life map 36 tracks assignments of blocks 26 to working storage and persistent storage functions. Processor 14 accesses blocks 26 through the memory life map 36 which may be cached in a structure which supplements or replaces current technology processor page tables. Thus the working storage or persistent storage physical location changes are transparent to the functions.

In operation of an example embodiment, block (1,1) is assigned as persistent storage and has an application written to it that is associated with a persistent storage function of periodic reads of information from block (1,1) to execute the information on processor 14. In the example embodiment, processor 14 reads information from block (1,1) to write the information in executable form at block (x,y). Over several usages of the application, block (1,1) has no writes while block (x,y) has multiple writes, resulting in no wear at block (1,1) and greater wear at block (x,y). During this usage, memory life manager 32 manages writes to block (x,y) to wear level across block (x,y) so that block (x,y) experiences relatively level wear of cells 24 within the block. After a predetermined differential of usage by writes builds between block (1,1) and block (x,y), memory life manager 32 adjusts map 36 to change block (1,1) to working storage function memory from persistent storage function memory and to change block (x,y) to persistent storage function memory from working storage function memory. In order to avoid an impact on operation of information handling system 10, the map adjustment is performed during times of relative inactivity. Note that for some applications and storage technologies, all wear leveling within working storage blocks might be deferred until the application is idle. Upon adjusting the map, memory life manager 32 commands DMA engine 36 to swap the information stored block (1,1) and block (x,y). By changing the type of data store on each block, greater numbers of writes will occur to block (1,1) resulting in wear leveling relative to block (x,y). In a fully operational universal memory 12, periodic swaps of blocks 26 will tend to wear level memory 12 as a whole over time, with the period for swapping low wear and high wear memory blocks based upon maintaining a desired maximum wear life differential across memory 12. A one-for-one memory block swap of a persistent storage block and working storage block maintains a desired balance in universal memory 12 of persistent storage and working storage blocks.

Function based wear leveling by swapping blocks 26 assigned to one of plural functions levels memory wear across blocks 26 while wear leveling within each block keeps each cell within a block 26 within a desire wear of other cells. Although memory life manager 32 is depicted as instructions executed within processor 14, the functions of memory life manager 32 may be spread between a variety of hardware, firmware and/or software devices, such as a memory controller of universal memory 12. Further, function based wear leveling across blocks of memory may occur in other types of memory, such as peripheral memory 20, which has firmware storage 38, file storage 40, file cache storage 42 and application storage 44. In one embodiment, instructions executing in I/O Hub 16 perform wear leveling of blocks based on functions 38-40 while also performing wear leveling within each block of functional storage as needed.

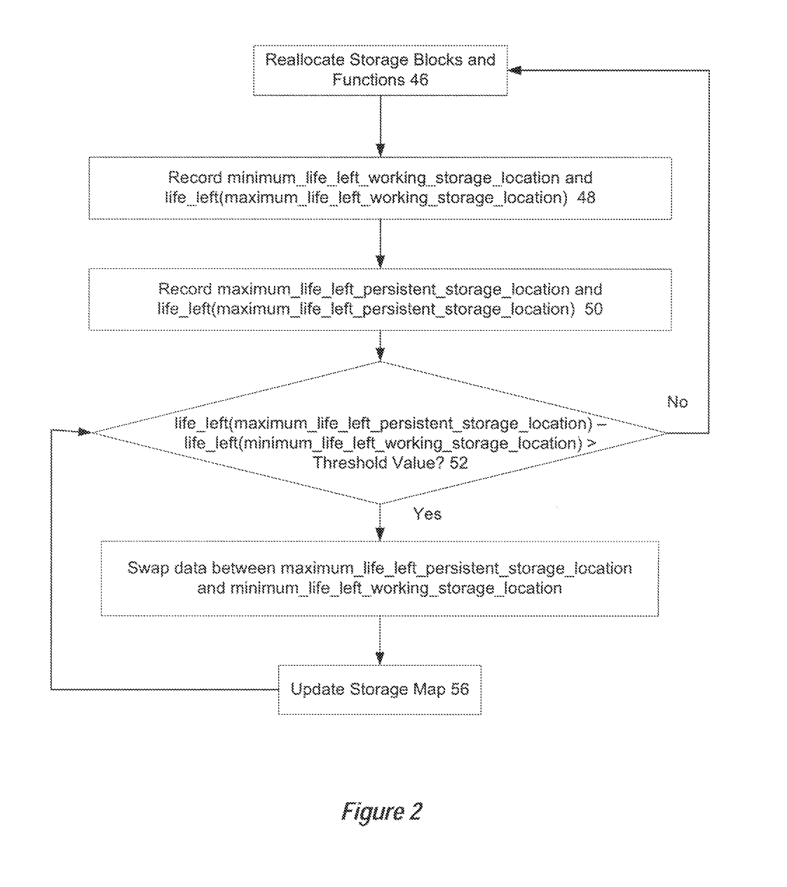

Referring now to FIG. 2, a flow diagram depicts a process for performing function-based wear leveling. The process begins at step 46 with a determination that a reallocation event or period has occurred. For example, reallocations may be initiated based on detection of idle time, based on real time system measurements of resource utilization, based upon detection of a cold boot, based upon write count thresholds, based upon user requests or based upon other factors. At step 48, a scan is performed for wear data of memory blocks assigned to working storage functions by recording the minimum life left for each block. At step 50, a scan is performed for wear data of memory blocks assigned to persistent storage functions by recording the maximum life left for each block. In summary, steps 48 and 50 are building a working table of block wear data. At step 52, a comparison of the relative life left for the blocks of memory is performed to identify persistent storage and working storage blocks that are to be swapped. For example, starting with the block of persistent storage that has the greatest life remaining and the block of working storage that has the least life remaining, the life left maximum is subtracted from the life left minimum to see if the difference is greater than a threshold value. If the threshold is exceeded, the blocks are tagged to be swapped and a comparison is performed on the next highest life remaining persistent storage and the next lowest life remaining working storage until the comparison fails to exceed the threshold. A threshold value is used to avoid excessive swapping since swapping itself creates memory wear. At step 54, the tagged blocks are swapped so that each persistent storage block has its information copied to the working storage block with which it was compared and vice versa. At step 56, the storage map is updated and the process returns to step 46 to await the next reallocation period. While awaiting the next reallocation period, wear leveling is performed within each block.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to cooperate to process information;
a memory having a universal architecture that supports at least a first and second function; and
a memory life manager interfaced with the memory and operable to track memory life, the memory manager further operable to assign the memory to plural blocks, each of the plural blocks associated with one of the functions and operable to wear level the memory by adjusting the function assigned to each block according to the memory life of each block.

2. The information handling system of claim 1 wherein the memory manager is further operable to wear level memory within each block according to the memory life within each block.

3. The information handling system of claim 1 wherein at least one of the at least first and second function comprise a working storage function and a persistent storage function.

4. The information handling system of claim 3 wherein at least one of the at least first and second function further comprise a firmware function.

5. The information handling system of claim 3 wherein at least one of the at least first and second function comprise a video buffer function.

6. The information handling system of claim 1 wherein the memory comprises flash memory.

7. The information handling system of claim 1 wherein the memory comprises phase change memory.

8. The information handling system of claim 1 wherein each of the blocks comprise a uniform size and wherein a predetermined number of blocks are assigned to each function.

9. The information handling system of claim 8 further comprising a memory map that associates each block with a function wherein adjusting the function assigned to each block comprises assigning the block a function in the memory map.

10. A method for memory wear leveling, the method comprising:
dividing the memory into plural blocks;
assigning each block to one of plural functions;
monitoring the blocks for memory life associated with each block; and
reassigning blocks to functions based on the memory life of the blocks and the memory usage of the functions.

11. The method of claim 10 further comprising performing memory wear leveling within each block.

12. The method of claim 10 wherein the plural functions comprise persistent storage.

13. The method of claim 10 wherein the plural functions comprise working storage.

14. The method of claim 10 wherein at least one of the plural functions comprises firmware storage.

15. The method of claim 10 wherein at least one of the plural functions comprises video buffer storage.

16. The method of claim 10 wherein each block comprises a predetermined number of adjacent memory cells.

17. The method of claim 16 wherein the predetermined number of adjacent memory cells comprise one MB of memory.

18. Memory comprising:
plural memory cells divided into plural blocks of substantially equal size;
a memory life manager interfaced with the plural memory cells and operable to assign each block to selected of plural functions, to periodically analyze the life of each block and function of each block, and to reassign at least some of blocks to different functions based on the analyzing so that blocks with greater remaining life are assigned to functions associated with greater numbers of writes and blocks with lesser remaining life are assigned to functions associated with lesser numbers of writes.

19. The memory of claim 18 wherein the memory life manager is further operable to level cell wear within each block.

20. The memory of claim 19 wherein the functions comprise at least a persistent storage function and a working storage function.
